(19) United States
(12) Patent Application Publication
(10) Pub. No.: US 2006/0285748 A1
(43) Pub. Date: Dec. 21, 2006

(54) Document processing device

(75) Inventors: Masakazu Tateno, Ashigarakami-gun (JP); Kei Tanaka, Tokyo (JP); Kotaro Nakamura, Tokyo (JP); Takashi Nagao, Ashigarakami-gun (JP); Masayoshi Sakakibara, Ebina-shi (JP); Xinyu Peng, Ebina-shi (JP); Teruka Saito, Ashigarakami-gun (JP); Toshiya Koyama, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/319,359

(22) Filed: Dec. 29, 2005

(30) Foreign Application Priority Data
Jun. 15, 2005 (JP) 2005-175615

(51) Int. Cl. G06K 9/00; G06F 17/28

(52) U.S. Cl. 382/181; 704/3

(57) ABSTRACT

A document processing device comprises: an image capturing unit that captures an image and acquires image data; a region separating section that extracts from the image data, image data of a printed region and image data of a hand-drawn region; a printed text data acquiring section that acquires printed text data in the printed region; a hand-drawn text data acquiring section that acquires hand-drawn text data in the hand-drawn region; a printed language specifying section that specifies language of the printed text data; a hand-drawn language specifying section that specifies language of the hand-drawn text data; a translation processing section that generates translated text data by translating the printed text data to the language that has been specified by the hand-drawn language specifying section.

### BACKGROUND

1. Technical Field

The present invention relates to technology for translating a document from one language to another by a computer.

2. Related Art

In recent years, translation devices are being used that convert a document from one language to another. Particularly, devices are being developed in which, when a translation source document (manuscript) has been provided as a paper document, the paper document is optically read and digitized, and after performing character recognition, automatic translation is performed (for example, JP H08-006948A).

When using a device as described above that performs automatic translation, it is necessary for a user to specify languages by inputting (or selecting) a translation source language and a translation destination language to that device. Such an input operation is often complicated, and there is the problem that when, for example, the user does not use the device on a daily basis, that input operation takes time and the user's work efficiency is decreased. In order to respond to such a problem, devices have been developed in which a message that prompts the user for operation input or the like is displayed on a liquid crystal display or the like, but even in this case, there is the problem that when, for example, the message is displayed in Japanese, a user who cannot understand Japanese cannot understand the meaning of the message that is displayed, and it is difficult to perform the input operation.

### SUMMARY

A document processing device comprises: an image capturing unit that captures an image from sheet-like media, and acquires image data that represents the image as a bitmap; a region separating section that extracts from the image data, image data of a printed region and image data of a hand-drawn region; a printed text data acquiring section that acquires printed text data that represents the contents of printed characters in the printed region; a hand-drawn text data acquiring section that acquires hand-drawn text data that represents the contents of hand-drawn characters in the hand-drawn region; a printed language specifying section that specifies the language of the printed text data; a hand-drawn language specifying section that specifies the language of the hand-drawn text data; a translation processing section that generates translated text data by translating the printed text data to the language that has been specified by the hand-drawn language specifying section.

### BRIEF DESCRIPTION OF THE DRAWINGS

Embodiments of the present invention will be described in detail based on the following figures, wherein:

FIG. 1 shows a document to which annotation has been added according to a first embodiment of the present invention;

FIG. 2 is a block diagram that shows a configuration of a multifunctional machine of the first embodiment;

FIG. 3 is a flowchart that shows the processing of a multifunctional machine of the first embodiment;

FIG. 4 shows a state of the first embodiment in which replacement to black pixels has been performed;

FIG. 5 shows a data configuration of a comparison image table according to a second embodiment of the present invention;

FIG. 6 is a flowchart that shows the processing of a multifunctional machine of the second embodiment;

FIG. 7 shows an example of an image captured in the second embodiment;

FIG. 8 is a flowchart that shows the processing of a multifunctional machine of a third embodiment of the present invention;

FIG. 9 is a block diagram that shows a configuration of a system according to a fourth embodiment of the present invention;

FIG. 10 is a block diagram that shows a configuration of an audio recorder of the fourth embodiment;

FIG. 11 is a block diagram that shows a configuration of a computer device of the fourth embodiment;

FIG. 12 is a flowchart that shows the processing of an audio recorder of the fourth embodiment;

FIG. 13 shows a document that has been given a barcode according to the fourth embodiment;

FIG. 14 is a flowchart that shows the processing of a multifunctional machine of the fourth embodiment;

FIG. 15 shows an example of a screen displayed on a computer device of the fourth embodiment; and

FIG. 16 is a block diagram that shows a configuration of a system according to a modified example of the present invention.

### DETAILED DESCRIPTION

Embodiment 1

Following is a description of a first embodiment of the present invention. First, the main terminology used in the present embodiment will be defined. The term “printed character” section a character obtained by transcribing a character shape of a specified typeface such as Gothic or Mincho, and the term “hand-drawn character” is used to mean a character other than a printed character. Further, the term “document” is used to mean a sheet-shaped medium (such as paper, for example) on which information is written as character orthography. Hand-drawn characters that pertain to the handling or correction of a passage written with printed characters and have been added by a person who has read that passage, are referred to as “annotation”.

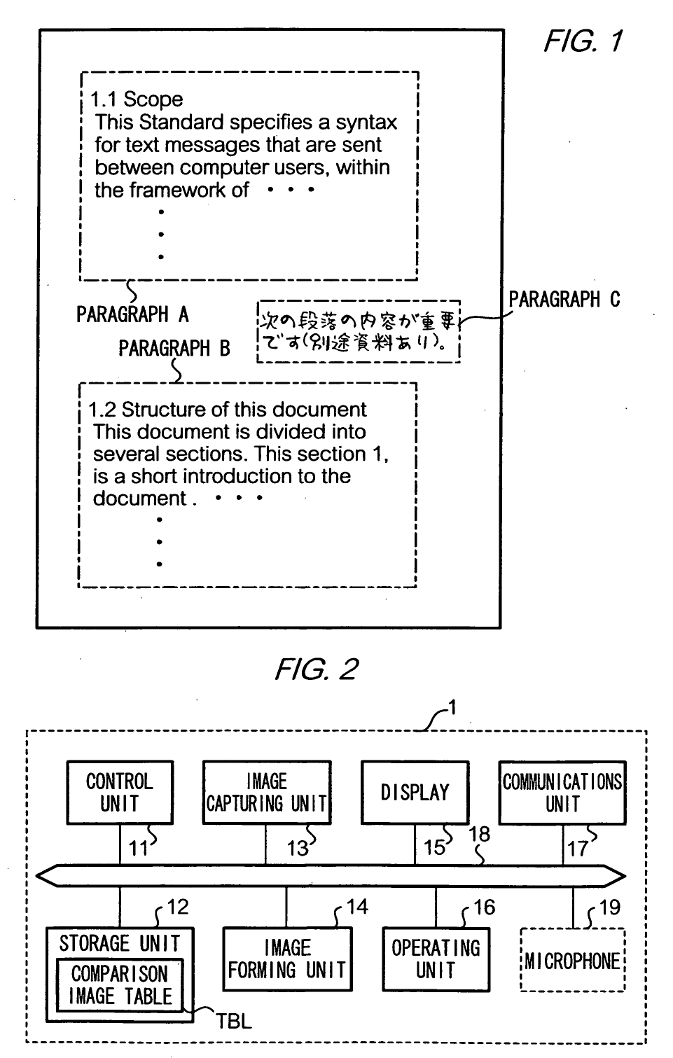

FIG. 1 shows an example of a document to which an annotation has been added. In the document shown in FIG. 1, a paragraph A and a paragraph B are written in printed characters on one page of paper, and an annotation C is added in hand-drawn characters.

Next is a description of the configuration of a multifunctional machine 1 of the present embodiment, with reference to the block diagram shown in FIG. 2. The multifunctional machine 1 is a device provided with a scanner that optically captures and digitizes a document. In FIG. 2, a control unit 11 is provided with a computing device such as a CPU (Central Processing Unit), for example. A storage unit 12 stores various programs such as a control program or translation program, and is configured from RAM (Random Access Memory), ROM (Read Only Memory), a hard disk, or the like. The control unit 11 controls the units of the multifunctional machine 1 via a bus 18 by reading and executing the programs that are stored in the storage unit 12.

An image capturing unit 13 optically scans a document and captures an image of that document. This image capturing unit 13 is provided with a loading unit in which a document is loaded, and captures an image of a document that has been loaded in this loading unit by optically scanning the document, and generates binary bitmap image data. An image forming unit 14 prints image data on paper. Based on the image data supplied by the control unit 11, the image forming unit 14 irradiates image light and forms a latent image on a photosensitive drum not shown in the figure due to a difference in electrostatic potential, makes this latent image a toner image by selectively affixing toner, and forms an image on the paper by transferring and affixing that toner image.

A display 15 displays an image or the like that shows a message or work status to a user, according to a control signal from the control unit 11, and is configured from a liquid crystal display or the like, for example. An operating unit 16 outputs a signal corresponding to the user's operation input and the on-screen display at that time, and is configured from a touch panel or the like in which a ten key, start button, and stop button are placed on a liquid crystal display. By the user operating the operating unit 16, it is possible to input an instruction to the multifunctional machine 1. A communications unit 17 is provided with various signal devices, and gives and receives data to and from other devices under the control of the control unit 11.

Operation of the present embodiment will now be described. First, the user of the multifunctional machine 1 inputs a translation instruction by operating the operating unit 16. Specifically, the user loads a document that will be the target of translation processing in the loading unit of the image capturing unit 13, and inputs a translation instruction to the multifunctional machine 1 by operating the operating unit 16.

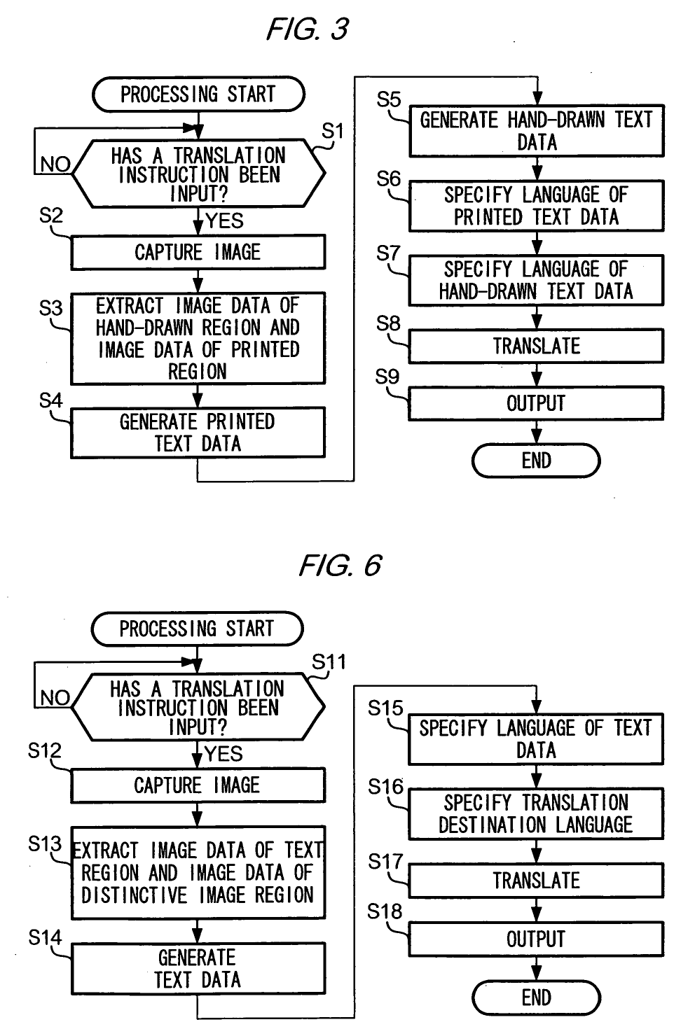

FIG. 3 is a flowchart that shows the processing performed by the control unit 11 of the multifunctional machine 1. When the control unit 11 of the multifunctional machine 1 detects that a translation instruction has been input (Step S1; Yes), it captures an image of the document (Step S2). That is, the control unit 11 controls the image capturing unit 13 so as to optically capture an image of the document, and generates bitmap image data.

Next, the control unit 11 extracts image data of a region in which printed characters are written (hereinafter, referred to as a “printed region”) and a region where hand-drawn characters are written (hereinafter, referred to as a “hand-drawn region”) from the image that has been generated, and separates the image data of the printed region and the image data of the hand-drawn region (Step S3).

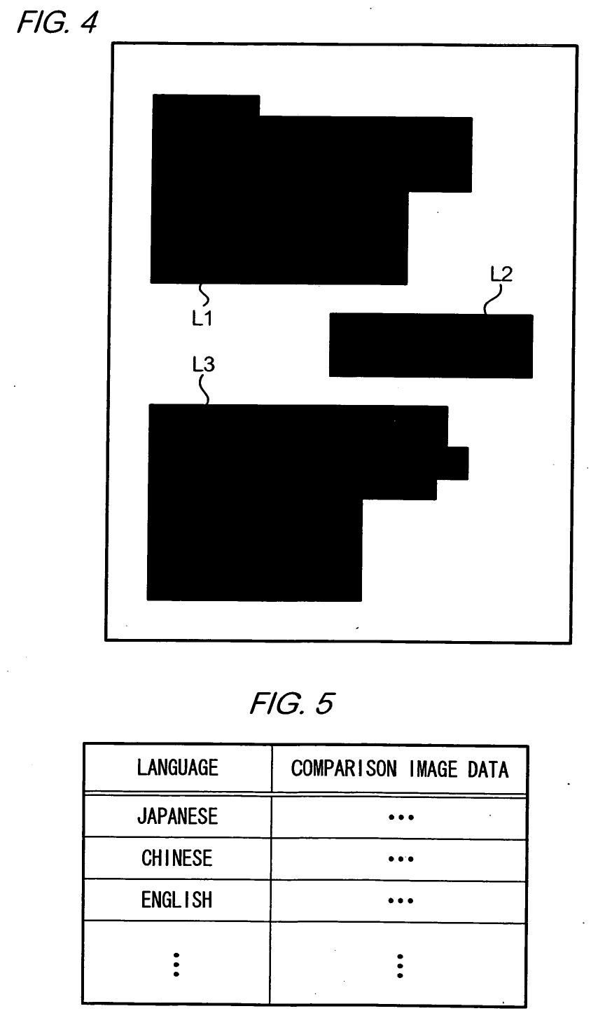

Extraction of image data is performed as follows. First, pixels represented by the image data of the document are scanned in the horizontal direction, and when the distance between two adjacent characters, that is, the width of a line of continuous white pixels, is less than a predetermined value X, those continuous white pixels are replaced with black pixels. This predetermined value X is made roughly equal to a value assumed to be the distance between adjacent characters. Likewise, the pixels are also scanned in the vertical direction, and when the width of a line of continuous white pixels is less than a predetermined value Y, those continuous white pixels are replaced with black pixels. This predetermined value Y is made roughly equal to a value assumed to be the interval between lines of characters. As a result, a region is formed that has been covered with black pixels. FIG. 4 shows a state in which the replacement processing described above has been performed in the document in FIG. 1. In FIG. 4, regions L1 to L3 that have been covered by black pixels are formed.

When a region that has been covered by black pixels is formed, the operation proceeds to judge whether each region is a printed region or a hand-drawn region. Specifically, first a noted region that will be the target of processing is specified, that black pixels that have been substituted within the specified region are returned to white pixels, and the contents of the original drawing are restored. Then, the pixels within that region are scanned in the horizontal direction, and it is judged whether or not the degree of variation in pitch of continuous white pixels is less than a predetermined value. Ordinarily, for a region in which printed characters have been written, the degree of variation in pitch of continuous white pixels is less than the predetermined value because the interval between two adjacent characters is about constant. On the other hand, for a region in which hand-drawn characters have been written, the degree of variation in pitch of continuous white pixels is larger than the predetermined value because the interval between two adjacent characters is not constant. When a judgment has been performed for the regions L1 to L3 shown in FIG. 4, regions L1 and L3 are judged to be printed regions, and region L2 is judged to be a hand-drawn region.

Following is a return to the description of FIG. 3. Next, the control unit 11 generates printed text data from the image data of the printed regions that represents the contents of the printed characters (Step S4). In this step the acquisition of printed text data is performed as follows. First, character images are extracted from the image data character by character and normalized. Then, the normalized images and the shape of characters that have been prepared in advance as a dictionary are compared by a so-called pattern matching method, and character codes of characters having the highest degree of similarity are output as recognition results.

Next, the control unit 11 generates hand-drawn text data from the image data of the hand-drawn regions that represents the contents of the hand-drawn characters (Step S5). In this step the acquisition of hand-drawn text data is performed as follows. First, character images are extracted from the image data by a character and normalized. Then, the characteristics of each constituent element of the characters are extracted from the normalized image, and by comparing those extracted characteristics to characteristic data that has been prepared in advance as a dictionary, constituent elements of characters are determined. Further, character codes of characters that have been obtained by assembling the determined constituent elements in their original manner are output.

Next, the control unit 11 specifies the language of the printed text data (Step S6). Specifically, the control unit 11 searches for a predetermined word(s) included in this printed text data, the words being unique to each language prepared in advance as a dictionary. The language of the searched words is specified to be the language of the printed text data. A language is specified in the same manner for the hand-drawn text data (Step S7).

The control unit 11 judges that the language of the printed text data is the translation source language, and that the language of the hand-drawn text data is the translation destination language, and generates translation text data by translating the printed text data from the translation source language to the translation destination language (Step S8). Then, the translation text data that shows the results of translating the printed text data and the hand-drawn text data is output and printed on paper by the image forming unit 14 (Step S9).

According to the present embodiment described above, when the multifunctional machine 1 reads a document to which an annotation has been added, the multifunctional machine 1 separates image data from that document into image data of a region in which printed characters have been written and image data of a region in which hand-drawn characters have been written, and acquires text data from each of the separated image data. Then, language judgment processing is performed for each of that data, so that a translation source language and translation destination language can be specified. As a result, if a user of the multifunctional machine 1 does not input a translation source language or translation destination language into the multifunctional machine 1, an original text is translated into a desired language by only performing just a simple operation of inputting translation instructions.

Embodiment 2

Following is a description of a second embodiment of the present invention. The hardware configuration of the multifunctional machine 1 of the present embodiment is the same as the first embodiment, except for storing a comparison image table TBL (shown by a dotted line in FIG. 2) in the storage unit 12.

The data structure of the comparison image table TBL is shown in FIG. 5. This table is used when the control unit 11 judges the translation destination language. As shown in FIG. 5, the items “language” and “comparison image data” are associated with each other and stored in the comparison image table TBL. Identification information with which it is possible to uniquely identify a language such as Japanese or English, for example, is stored in “language”, and image data of a passport of a country corresponding to the language is stored as comparison image data in “comparison image data”. The control unit 11 of the multifunctional machine 1 in the present embodiment compares image data that has been captured by the image capturing unit 13 with the comparison image data that is stored in the comparison image table TBL, and specifies a translation destination language based on the degree of agreement between the captured image data and the comparison image data. This specification processing is performed using, for example, an SVM (support vector machine) algorithm or the like.

Next is a description of the operation of the present embodiment. First, the user of the multifunctional machine 1 inputs a translation instruction by operating the operating unit 16. Specifically, the user loads a document that will be the target of translation processing along with their own passport (distinctive image) in the loading unit of the image capturing unit 13, and inputs a translation instruction to the multifunctional machine 1 by operating the operating unit 16.

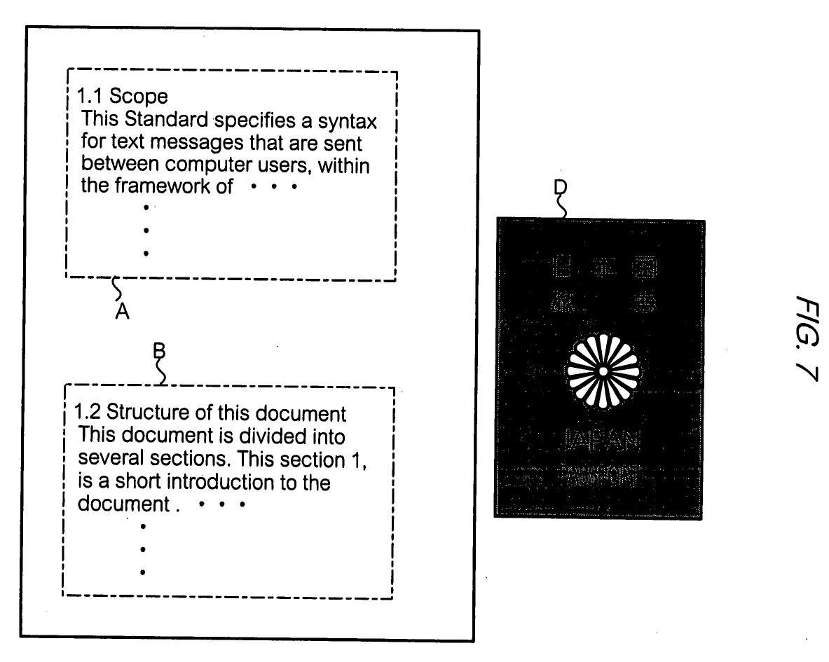

FIG. 6 is a flowchart that shows the processing performed by the control unit 11 of the multifunctional machine 1. When the control unit 11 of the multifunctional machine 1 detects that a translation instruction has been input (Step S11; Yes), it controls the image capturing unit 13 so as to capture an image of the document and the passport on the image capturing unit 13 (Step S12). FIG. 7 shows an example of an image captured by the image capturing unit 13. In the example shown in FIG. 7, a document in which the paragraph A and the paragraph B have been written and a passport image D are captured.

Next, the control unit 11 performs layout analysis or the like using a predetermined algorithm or the like for image data, and extracts character region image data and passport image region image data (distinctive image region) (Step S13). Specifically, image data is divided into predetermined regions, and the types of the regions (such as character or drawing) is judged (Step S13). In the example shown in FIG. 7, it is judged that the region in which the paragraph A and paragraph B are written is a character region and the region of the passport image D is a distinctive image region.

Next, the control unit 11 generates text data from the image data of the character region (Step S14), and specifies the language of the generated text data (Step S15). This processing is performed in the same manner as the first embodiment. Next, the control unit 11 compares the image data of the distinctive image region extracted in Step S13 and the passport image data stored in the comparison image table TBL, and specifies a translation destination language based on the degree of agreement of that image data (Step S16).

The control unit 11 judges that the language of the text data is the translation source language and the language that has been specified from the passport image data (distinctive image data) is the translation destination language, translates the text data from the translation source language to the translation destination language, and generates translated text data (Step S17). Then, the translation text data that shows the results of translating the text data is output and printed on paper by the image forming unit 14 (Step S18).

According to the present embodiment described above, when the multifunctional machine 1 reads a document and a distinctive image that specifies a language (passport image), the multifunctional machine 1 separates image data of a region in which characters have been written and image data of a region in which a distinctive image has been formed, specifies the translation destination language from the image data of the distinctive image and acquires text data from the image data of the region in which characters have been written, and specifies the language of that text data. In other words, it is possible to respectively specify the translation source language from the text data and the translation destination language from the image data of the distinctive image. As a result, if a user of the multifunctional machine 1 does not input a translation source language or translation destination language into the multifunctional machine 1, an original document is translated into a desired language by performing just a simple operation of inputting translation instructions, while improving work efficiency of the user.

Embodiment 3

Following is a description of a third embodiment of the present invention. The hardware structure of the multifunctional machine 1 of the present embodiment is the same as the first embodiment, except for being provided with a microphone 19 (shown by a dotted line in FIG. 2). The microphone 19 is an audio input device that picks up a sound, and in the present embodiment, the control unit 11 of the multifunctional machine 1 performs A/D conversion or the like for audio picked up by this microphone 19, and generates digital audio data.

Following is a description of the operation of the present embodiment. First, a user of the multifunctional machine 1 inputs a translation instruction by operating the operating unit 16 of the multifunctional machine 1. Specifically, the user inputs a translation instruction to the multifunctional machine 1 by putting a document that will be the target of translation processing on the loading unit of the image capturing unit 13 of the multifunctional machine 1 and operating the operating unit 16, and pronounces some words of the translation destination language toward the microphone 19.

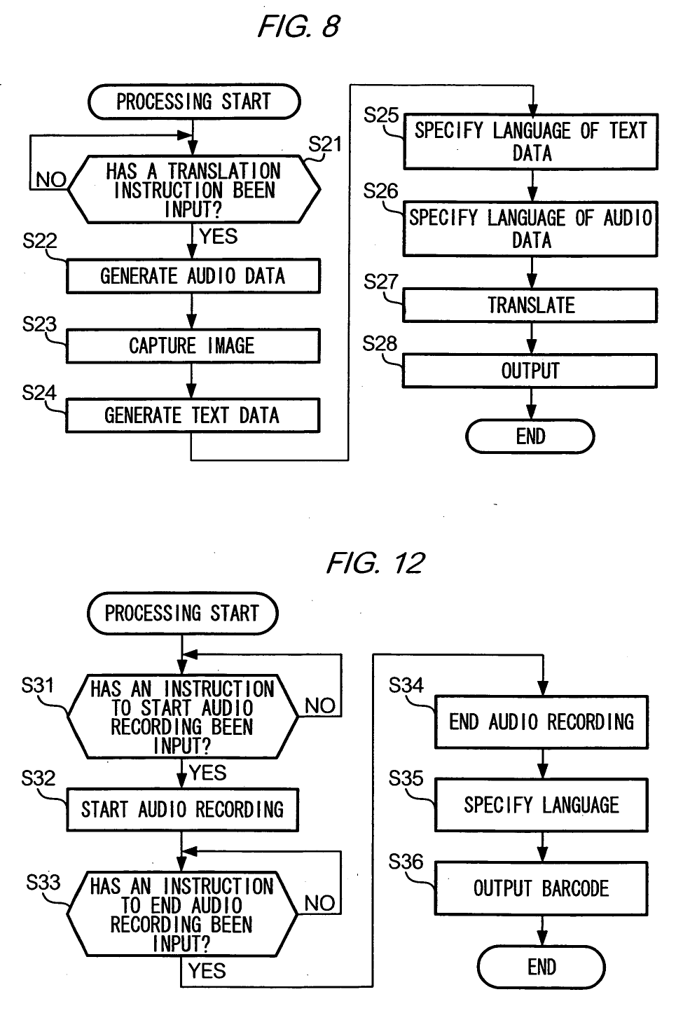

FIG. 8 is a flowchart that shows the processing performed by the control unit 11 of the multifunctional machine 1. When the control unit 11 of the multifunctional machine 1 detects that a translation instruction has been input (Step S21; Yes), first the control unit 11 generates digital audio data from the sound picked up by the microphone 19, and stores it in the storage unit 22 (Step S22). Next, bitmap image data is generated by performing image capture of the document (Step S23), and text data is generated that represents character contents from the captured image data (Step S24). Then, a language is specified from the text data (Step S25).

Next, the language of the audio data generated by Step S22 is determined (Step S26). This determination is performed as follows. A control unit 21 searches for the a predetermined word(s) unique to each language that have been prepared in advance as a dictionary, and determines the language having the searched word(s) to be the language of the audio data. It is preferable that the predetermined word(s) is selected among words of frequent use, such as “and”, “I”, or “we” in the case of English, or conjunctions, prefixes and the like.

The control unit 11 judges the language of the text data to be the translation source language and the language that has been specified from the audio data to be the translation destination language, translates the text data from the translation source language to the translation destination language, and generates translated text data (Step S27). Then, the translated text data is output and the translated text is printed on paper by the image forming unit 14 (Step S28).

According to the present embodiment described above, text data is obtained from the image data of the document, the language of that text data is specified, and the translation destination language is specified from the audio data that represents the audio that has been gathered. In this manner, if the user of the multifunctional machine 1 does not input a translation source language or translation destination language into the multifunctional machine 1, an original text is translated into a desired language by performing just a simple operation of inputting translation instructions and audio, while improving the work efficiency of the user.

Embodiment 4

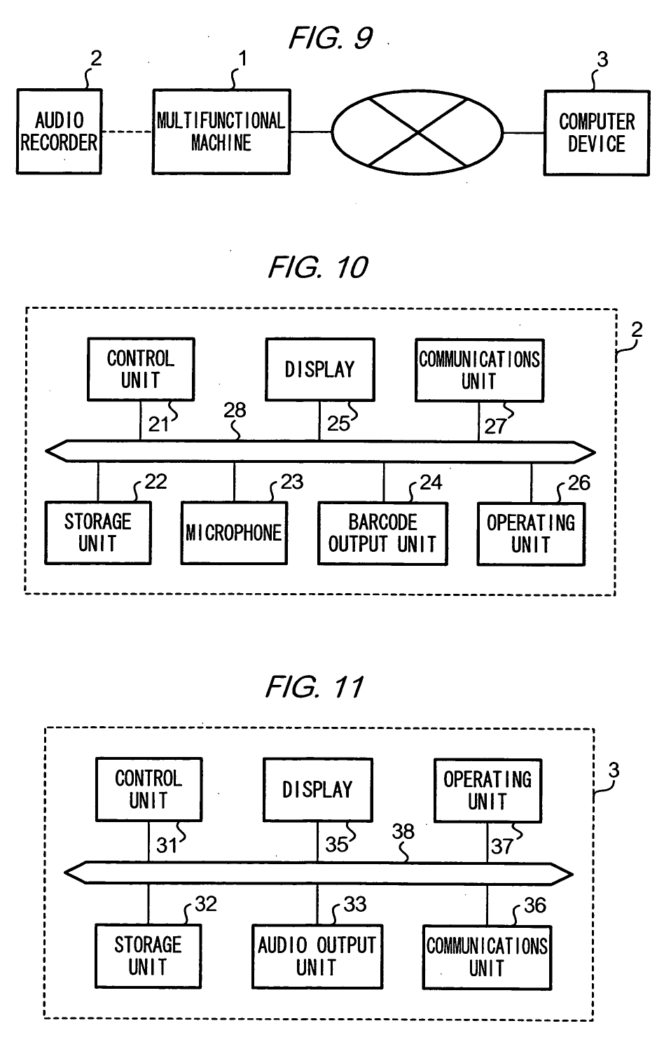

Following is a description of a fourth embodiment of the present invention. FIG. 9 is a block diagram that shows the configuration of the system according to the present embodiment. As shown in FIG. 9, this system is configured from the multifunctional machine 1, an audio recorder 2, and a computer device 3. The hardware configuration of the multifunctional machine 1 in the present embodiment is the same as the first embodiment. Thus, in the following description the same reference numerals are used as in the first embodiment, and a detailed description thereof is omitted.

Next is a description of the configuration of the audio recorder 2 with reference to the block diagram shown in FIG. 10. The audio recorder 2 is a device that gathers audio and generates digital audio data. In the figure, a control unit 21 is provided with a computing device such as a CPU, for example. A storage unit 22 is configured from RAM, ROM, a hard disk, or the like. The control unit 21 controls the units of the audio recorder 2 via a bus 28 by reading and executing programs that are stored in the storage unit 22. A microphone 23 picks up a sound. The control unit 21 performs A/D conversion or the like for a sound picked up by the microphone 23, and generates digital audio data.

A display 25 displays an image or the like that shows a message or work status to a user, according to a control signal from the control unit 21. An operating unit 26 outputs a signal corresponding to the user's operation input and the on-screen display at that time, and is configured by a start button, a stop button and the like. It is possible for a user to input instructions to the audio recorder 2 by operating the operating unit 26 while looking at an image or message displayed in the display 25. A communications unit 27 includes one or more signal processing devices or the like, and gives and receives data to and from the multifunctional machine 1 under the control of the control unit 21.

A barcode output unit 24 outputs a barcode by printing it on paper. The control unit 21 specifies a language by analyzing audio data with a predetermined algorithm, and converts information that represents the language that has been specified to a barcode. The barcode output unit 24 outputs this barcode by printing it on paper under the control of the control unit 21.

Next is a description of the configuration of the computer device 3 with reference to the block diagram shown in FIG. 11. As shown in FIG. 11, the computer device 3 is provided with a display 35 such as a computer display or the like, an operating unit 36 such as a mouse, keyboard, or the like, an audio output unit 33 that outputs audio, and a communications unit 37, as well as a control unit 31 that controls the operation of the entire device via a bus 38 and a storage unit 32 configured by RAM, ROM, a hard disk or the like.

Next is a description of the operation of the present embodiment. In the following description, audio data that is generated by a user's voice explaining the importance, the general outline of the document, or other information on the document is referred to as “audio annotation”.

First, the operation in which the audio recorder 2 generates an audio annotation will be explained with reference to the flowchart in FIG. 12. First the user inputs an instruction to start audio recording by operating the operating unit 26 of the audio recorder 2. When the control unit 21 of the audio recorder 2 detects that an instruction to start audio recording has been input (Step S31; YES), it allows sound to be picked up via the microphone 23 and starts generating audio data in digital form (Step S32). Next, when the control unit 21 detects that an instruction to end audio recording has been input (Step S33; YES), it ends the generation of audio data (Step S34). The audio data generated here is used as audio annotation by the processing of the multifunctional machine 1. Details of the processing will be described later. Next, the control unit 21 of the audio recorder 2 specifies the language of the generated audio annotation (Step S35). This judgment is performed in the manner described below. The control unit 21 searches for a predetermined word(s) included in this audio annotation, the word(s) being unique to each language that have been prepared in advance as a dictionary, and specifies the language having the searched words to be the language of the audio annotation.

When a language is specified, the control unit 21 of the audio recorder 2 converts information that includes the specified language and an ID (identifying information) for that audio annotation to a barcode, and allows that barcode to be output by the barcode output unit 24 by printing that barcode on paper (Step S36).

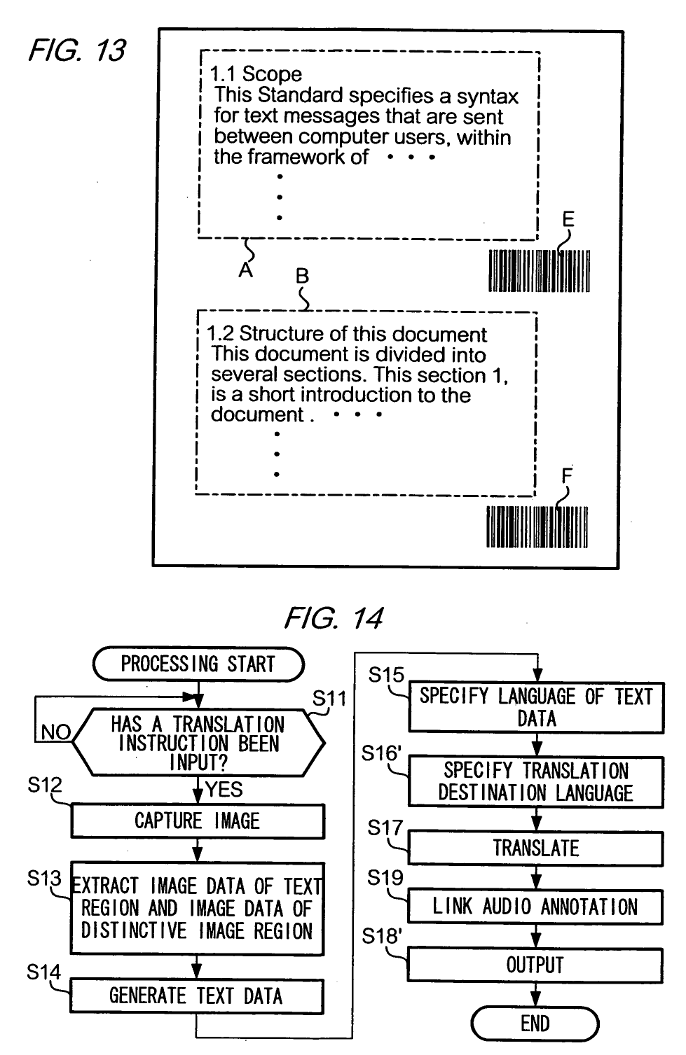

An audio annotation and a barcode that represents the audio annotation are generated by the above processing. The user of the audio recorder 2 attaches the barcode that has been output to a desired location of the document. FIG. 13 shows an example of a document to which a barcode has been attached. In the document shown in FIG. 13, a paragraph A and a paragraph B are written in characters on one page of paper, and in addition a barcode E corresponding to an audio annotation is attached to the document.

Next is a description of the operation of the multifunctional machine 1. First the user of the multifunctional machine 1 inputs a translation instruction by operating the operating unit 16 of the multifunctional machine 1 and the operating unit 26 of the audio recorder 2. Specifically, the user inputs a send instruction to send the audio annotation to the multifunctional machine 1 by operating the operating unit 26 of the audio recorder 2, and inputs a translation instruction to the multifunctional machine 1 by putting a document that will be the target of translation processing on the loading unit of the image capturing unit 13 of the multifunctional machine 1 and operating the operating unit 16.

FIG. 14 is a flowchart that shows the processing performed by the control unit 11 of the multifunctional machine 1. The processing of the control unit 11 shown in FIG. 11 differs from the processing shown in FIG. 6 for the second embodiment in that in the processing that specifies a translation destination language (the processing shown in Step S16), the language is specified using a barcode instead of using a passport image as distinctive image data, and the audio annotation is output by sending it after being linked to the translated text data. Other processing (Steps S11 to S15, S17) is the same as that of the second embodiment. Thus, in the following description, only differing points are described above, and the processing that is the same as in embodiment 2 using the same reference numerals is omitted.

In the second embodiment, image data of the distinctive image region that is extracted in Step S13 of FIG. 6 and passport image data stored in the comparison image table TBL are compared, and a translation destination language is specified based on the degree of agreement between the extracted image data and the passport image data (see Step S16 of FIG. 6). In the present embodiment, however, a translation destination language is specified by analyzing a barcode (distinctive image data) with a predetermined algorithm (Step S16′).

Next, the control unit 11 judges the language of the text data to be the translation source language, and the language that has been specified from the barcode (distinctive image data) to be the translation destination language, and generates translated text data by translating the text from the translation source language to the translation destination language (Step S17). Next, the audio annotation received from the audio recorder 2 is linked to the translated text data (Step S19), and output by sending it to the computer device 3 via the communication unit 17 (Step S18′). Accordingly, the translated text data to which the audio annotation has been added is sent to the computer device 3.

Next, the user operates the computer device 3 to display the translated text data received from the multifunctional machine 1 on the display 35. When the control unit 31 of the computer device 3 detects that a command to display the translated text data has been input, the translated text data is displayed on the display 35.

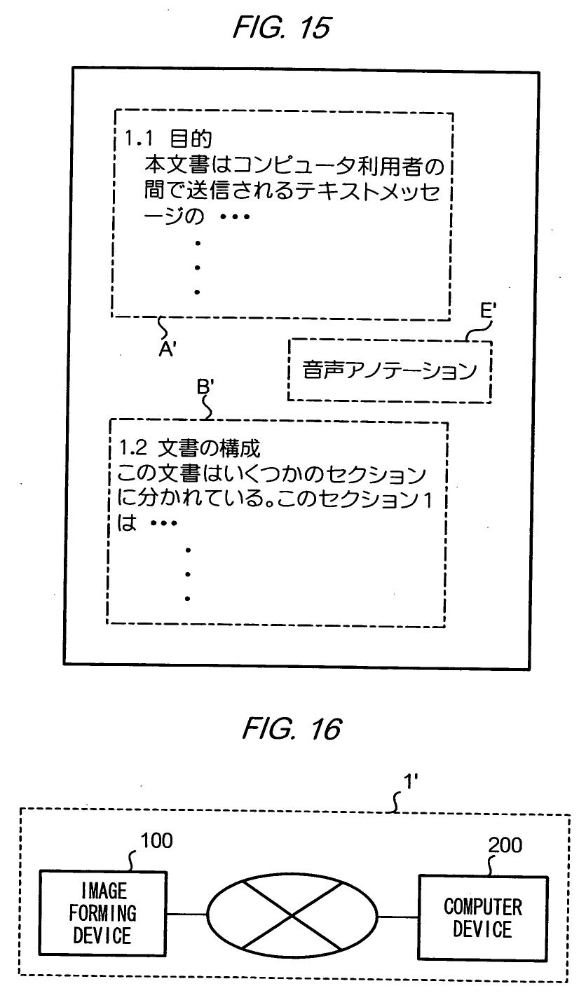

FIG. 15 shows an example of a display displayed on the display 35 of the computer device 3. As shown in the figure, translation data is displayed in a display region A′ and B′, and information that shows that an audio annotation is added (for example, a character, icon, or the like) is displayed in a region E′. By referring to the display displayed on the display 35 of the computer device 3, the user can check those translation results. Also, when the user performs an operation of moving a mouse pointer to the region E′ and clicking the left button, the control unit 31 of the computer device 3 allows an audio annotation corresponding to the information displayed in that region E′ to be output as audio by the audio output unit 33.

According to the present embodiment as described above, when the multifunctional machine 1 reads a document and a distinctive image that specifies a language (a barcode), the multifunctional machine 1 separates image data from that document into image data of a region in which printed characters have been written and image data of a region in which a distinctive image has been formed, specifies a translation destination language from the image data of the distinctive image, acquires text data from the image data of the region in which printed characters have been written, and specifies a language for that text data. Namely, a translation source language can be specified from the text data, and a translation destination language can be specified from the image data of the destination image. By adopting such a configuration, if the user of the multifunctional machine 1 does not input a translation source language or translation destination language into the multifunctional machine 1, an original text is translated into a desired language by performing just a simple operation of inputting a translation instruction, and thus the work efficiency of the user is improved.

In the embodiment described above, an operation is described that translates a document to which one barcode has been added, but as shown for example by dotted line F in FIG. 13, the number of added barcodes may of course be a plural number of two or more. Even when multiple barcodes have been added, the control unit 11 of the multifunctional machine 1 specifies a translation destination language from the barcodes and performs processing that translates into that language by performing the same processing as described above.

### MODIFIED EXAMPLES

Embodiments of the present invention are described above, but the present invention is not limited to the aforementioned embodiments, and can be embodied in various other forms. Examples of such other forms are given below.
(1) In the first embodiment described above, when the multifunctional machine 1 reads a document and generated image data for that document, the multifunctional machine 1 respectively extracted image data of a hand-drawn region and a printed region, obtained text data from that image data, and performed translation processing. On the other hand, a configuration may also be adopted in which a plural number of two or more devices that have been connected by a communications network share the functions of the above embodiment, and a system provided with that plural number of devices allows the multifunctional machine 1 of that embodiment to be realized. An example of such a configuration is described below with reference to FIG. 16. In FIG. 16, reference numeral 1′ is a document processing system in which an image forming device 100 and a computer device 200 have been connected by a communications network. In this document processing system 1′, the image forming device 100 implements functions that correspond to the image capturing unit 13 and the image forming unit 14 of the multifunctional machine 1 of the first embodiment, and the computer device 200 implements processing such as extraction of hand-drawn and printed regions, generation of text data from image data, and translation processing.

Likewise with respect to the second through fourth embodiments, a configuration may also be adopted in which a plural number of two or more devices connected by a communications network share the functions of those embodiments, and a system provided with that plural number of devices allows the multifunctional machine 1 of those embodiments to be realized. For example, with respect to the second embodiment, a configuration may also be adopted in which a dedicated server device that stores the comparison image table TBL is provided separate from the multifunctional machine, and the multifunctional machine makes an inquiry to that server device for the results of specifying a language.
(2) Also, in the above first through third embodiments, a configuration is adopted in which translated text data that represented the results of translation is output by printing on paper, but the method of outputting translated text data is not limited to this; a configuration may also be adopted in which the control unit 11 of the multifunctional machine 1 sends the translated text data to another device such as a personal computer or the like via the communications unit 17, thereby outputting the translated text data. A configuration may also be adopted in which the multifunctional machine 1 is equipped with a display for displaying a translated text.
(3) A configuration may also be adopted in which the separation of printed and hand-drawn regions when image data of a printed region and image data of a hand-drawn region is extracted from image data in the above first embodiment is realized by a technique other than that disclosed in the above embodiment. For example, a configuration may be adopted in which the average thickness of the strokes of each character within the noted region is detected, and when a value that represents this thickness is greater than a threshold value that has been set in advance, that region is judged to be a region in which printed characters are written. A configuration may also be adopted in which the straight line components and the non-straight line components of each character within the noted region are quantified, and when the percentage of the non-straight line components occupied by the straight-line components is greater than a predetermined threshold value, that region is judged to be a region in which printed characters are written. Simply put, a configuration may be adopted in which the image data of a printed region in which printed characters are written and the image data of a hand-drawn region in which hand-drawn characters are written is extracted based on a predetermined algorithm.
(4) Also, in the above first through fourth embodiments, a configuration is adopted in which the language of text data is specified by searching for a predetermined word(s) included in the text data, the word(s) being unique to each language. However, the method of specifying a language is not limited to this; any technique may be adopted in which it is possible to suitably specify a language. Likewise with respect to the method of specifying a language for the audio data in the third and fourth embodiments, any technique may be adopted in which it is possible to suitably specify a language.
(5) Also, in the above second through fourth embodiments, a configuration is adopted in which a passport image and a barcode are used as distinctive images for specifying a translation destination language. However, the distinctive image is not limited to a passport image or a barcode; any specified image may be adopted with which it is possible to specify a language, such as an image of a coin or a banknote, for example. When paper currency is used as the distinctive image, image data of currency of the country corresponding to the language is stored in the “comparison image data” of the comparison image table TBL. A configuration may be adopted in which the user, when inputting a translation instruction, puts the currency of the country corresponding to the translation destination language along with the document to be translated on the loading unit of the image capturing unit 13.

The distinctive image may also be, for example, a logo, a pattern image, or the like. A configuration may also be adopted in which, even when a logo, a pattern image, or the like are used as the distinctive image, image data for comparison is stored in the comparison image table TBL, same as in the above embodiment, and a translation destination language is specified by matching image data, or a translation destination language is specified using a predetermined algorithm for analyzing those pattern images or the like.

In the second embodiment, a configuration is adopted in which the multifunctional machine 1 simultaneously scans a document and a distinctive image that specifies a language, and image data of a character region and image data of a distinctive image region are extracted from the generated image data. However, a configuration may also be adopted in which the document and the distinctive image are separately scanned, and the image data of the document and the image data of the distinctive image are separately generated. For example, a configuration may be adopted in which a distinctive image input unit (loading unit) that inputs a distinctive image such as a passport or the like is provided separately from a document image input unit (loading unit), and the user inputs the distinctive image from the distinctive image input unit.

As described above, the present invention provides a document processing device that includes an image capturing unit that captures an image from sheet-like media, and acquires image data that represents the image as a bitmap, a region separating section that extracts from the image data image data of a printed region in which printed characters are written and image data of a hand-drawn region in which hand-drawn characters are written, a printed text data acquiring section that acquires printed text data that represents the contents of printed characters in the printed region from the image data of the printed region, a hand-drawn text data acquiring section that acquires hand-drawn text data that represents the contents of hand-drawn characters in the hand-drawn region from the image data of the hand-drawn region, a printed language specifying section that specifies the language of the printed text data, a hand-drawn language specifying section that specifies the language of the hand-drawn text data, a translation processing section that generates translated text data by translating the printed text data from the language that has been specified by the printed language specifying section to the language that has been specified by the hand-drawn language specifying section, and an output unit that outputs the translated text data.

According to this document processing device, image data of a region in which printed characters have been written and image data of a region in which hand-drawn characters have been written is separated from the document, and text data is individually acquired from the respective image data that has been separated. By specifying languages for the respective image data, it is possible to specify a translation source language and a translation destination language.

Also, the present invention provides a document processing device that includes an image capturing unit that captures an image from sheet-like media, and acquires image data that represents the image as a bitmap, a region separating section that extracts from the image data image data of a character region in which characters are written and distinctive image data of a distinctive image region in which a distinctive image is formed that specifies a language, a text data acquiring section that acquires text data that represents the contents of characters in the character region from the image data of the character region, a character language specifying section that specifies the language of the text data, a translation destination language specifying section that specifies a translation destination language by analyzing the distinctive image data of the distinctive image region with a predetermined algorithm, a translation processing section that generates translated text data by translating the text data from the language that has been specified by the character language specifying section to the translation destination language, and an output unit that outputs the translated text data.

According to this document processing device, image data of a region in which a distinctive image is formed that specifies a language and image data of a region in which characters are written is separated from the document, a translation destination language is specified from the image data of the distinctive image, text data is acquired from the image data of the region in which characters are written, and the language of that text data is specified. That is, it is possible to respectively specify the translation source language from the text data and the translation destination language from the image data of the distinctive image.

Also, the present invention provides a document processing device that includes an image capturing unit that captures an image from sheet-like media, and acquires image data that represents the image as a bitmap, a distinctive image capturing unit that scans a distinctive image that specifies a language, and acquires distinctive image data that represents the contents of the distinctive image as a bitmap, a text data acquiring section that acquires text data that represents the contents of characters from the image data, a character language specifying section that specifies the language of the text data, a translation destination language specifying section that specifies a translation destination language by analyzing the distinctive image data with a predetermined algorithm, a translation processing section that generates translated text data by translating the text data from the language that has been specified by the character language specifying section to the translation destination language, and an output unit that outputs the translated text data.

According to this document processing device, the translation destination language is specified from the image data of the distinctive image, text data is acquired from the image data of the document, and the language of that text data is specified. That is, it is possible to respectively specify the translation source language from the text data and the translation destination language from the image data of the distinctive image.

In an embodiment of the present invention, a configuration may be adopted in which a storage unit is provided that stores multiple sets of comparison image data, the translation destination language specification unit compares the distinctive image data with the comparison image data that has been stored in the storage units, and the translation destination language is specified based on the degree of agreement between the distinctive image data and the comparison image data.

Also, in another embodiment of the present invention, a configuration may be adopted in which the comparison image data is image data that shows an image of at least one of a passport, currency (a coin, a banknote, etc.), or barcode.

Also, the present invention provides a document processing device that includes an image capturing unit that captures an image from sheet-like media, and acquires image data that represents the image as a bitmap, a text data acquiring section that acquires text data that represents the contents of characters from the image data, a character language specifying section that specifies the language of the text data, an audio input section that picks up a sound to generate audio data, a translation destination language specifying section that specifies a translation destination language by analyzing the audio data with a predetermined algorithm, a translation processing section that generates translated text data by translating the text data from the language that has been specified by the character language specifying section to the translation destination language, and an output unit that outputs the translated text data

According to this document processing device, text data is acquired from the image data of the document, the language of that text data is specified, and a translation destination language is specified from the audio data of audio that has been collected. It is possible to respectively specify the translation source language from the text data and the translation destination language from the audio data.

According to an embodiment of the present invention, it is possible to perform translation processing by judging a translation destination language without a user inputting a translation destination language.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments are chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-175615 filed on Jun. 15, 2005, including specification claims, drawings and abstract is incorporated herein by reference in its entirety.

What is claimed is:

1. A document processing device comprising:
an image capturing unit that captures an image and acquires image data;
a region separating section that extracts from the image data, image data of a printed region in which printed characters are written and image data of a hand-drawn region in which hand-drawn characters are written;
a printed text data acquiring section that acquires printed text data from the image data of the printed region;
a hand-drawn text data acquiring section that acquires hand-drawn text data from the image data of the hand-drawn region;
a printed language specifying section that specifies language of the printed text data;
a hand-drawn language specifying section that specifies language of the hand-drawn text data;
a translation processing section that generates translated text data by translating the printed text data from the language that has been specified by the printed language specifying section to the language that has been specified by the hand-drawn language specifying section; and
an output unit that outputs the translated text data.

2. A document processing device comprising:
an image capturing unit that captures an image and acquires image data;
a region separating section that extracts from the image data, image data of a character region in which characters are written and distinctive image data of a distinctive image region in which a distinctive image is formed that specifies a language;
a text data acquiring section that acquires text data from the image data of the character region;
a character language specifying section that specifies language of the text data;
a translation destination language specifying section that specifies a translation destination language by analyzing the distinctive image data of the distinctive image region with a predetermined algorithm;
a translation processing section that generates translated text data by translating the text data from the language that has been specified by the character language specifying section to the translation destination language; and
an output unit that outputs the translated text data.

3. The document processing device according to claim 2, further comprising:
a storage section that stores a plurality of sets of comparison image data and language information for translation destination language; and
wherein the translation destination language specifying section specifies the translation destination language by comparing the distinctive image data to the comparison image data that has been stored in the storage section.

4. A document processing device comprising:
an image capturing unit that captures an image and acquires image data;
a distinctive image capturing unit that scans a distinctive image that specifies a language, and acquires distinctive image data;
a text data acquiring section that acquires text data from the image data;
a character language specifying section that specifies the language of the text data;
a translation destination language specifying section that specifies a translation destination language by analyzing the distinctive image data with a predetermined algorithm;
a translation processing section that generates translated text data by translating the text data from the language that has been specified by the character language specifying section to the translation destination language; and
an output unit that outputs the translated text data.

5. The document processing device according to claim 4, further comprising:
a storage section that stores a plurality of sets of comparison image data and language information for translation destination language; and
wherein the translation destination language specifying section specifies the translation destination language by comparing the distinctive image data to the comparison image data that has been stored in the storage section.

6. The document processing device according to claim 5, wherein the comparison image data is image data that represents an image of at least one of a passport, paper currency, hard currency, or barcode.

7. A document processing device comprising:
an image capturing unit that captures an image and acquires image data;
a text data acquiring section that acquires text data from the image data;
a character language specifying section that specifies language of the text data;
an audio input unit that detects a sound to generate audio data;
a translation destination language specifying section that specifies a translation destination language by analyzing the audio data with a predetermined algorithm;
a translation processing section that generates translated text data by translating the text data from the language that has been specified by the character language specifying section to the translation destination language; and
an output unit that outputs the translated text data.
